(19) United States
(12) Patent Application Publication
(10) Pub. No.: US 2006/0051000 A1
(43) Pub. Date: Mar. 9, 2006

(54) Laser surface textured fluid-film bearing

(76) Inventors: Izhak Etsion, Haifa (IL); Victor Brizmer, Haifa (IL); Yuri Kligerman, Haifa (IL)

Correspondence Address: Mark Friedman;Bill Polkinghorn, 9003 Florin Way, Upper Marlboro, MD, 20772, US

(21) Appl. No.: 10/541,754

(22) PCT Filed: Jan. 11, 2004
(86) PCT No.: PCT/IL04/00021

§ 371 Date: Jul. 8, 2005

Related U.S. Application Data
(60) Provisional application No. 60/438,792, filed on Jan. 9, 2003.

(51) Int. Cl. F16C 32/06

(52) U.S. Cl. 384/100

(57) ABSTRACT

A fluid-film bearing including: (a) a first surface region having a first bearing surface, for attaching to a first machine component; (b) a second surface region having a second bearing surface, for attaching to a second machine component; the surface regions designed and configured such that first surface and the second surface are disposed opposite one another, the surface regions further designed and configured such that the first surface and the second surface move in a relative motion with respect to one another and (c) a fluid disposed between the surfaces, wherein at least one of the surfaces is a micropore-containing surface having a plurality of micropores disposed so as to effect an equivalent clearance convergence between the surfaces, in a direction of the relative motion, such that the relative motion, acting on the fluid, generates a pressure so as to generate a lifting force between the surfaces.

This application draws priority from U.S. Provisional Patent application Ser. No. 60/438,792, filed Jan. 9, 2003.

### FIELD AND BACKGROUND OF THE INVENTION

The present invention relates to thrust bearings, and, more particularly, to a parallel thrust bearing that achieves a satisfactory load carrying capacity by means of a laser-textured surface.

The classical theory of hydrodynamic lubrication yields a linear (Couette) velocity distribution having zero pressure gradients between smooth parallel surfaces under steady state sliding. This results in an unstable hydrodynamic film that would collapse under any external force acting normal to the surfaces. However, experience shows that stable lubricating films can develop between parallel sliding surfaces, generally because of some mechanism, which relaxes one or more of the assumptions of the classical theory. Many investigators have considered various load-support mechanisms with parallel surfaces. These mechanisms include lubricant viscosity change, wobble and bounce, non-Newtonian effects, and surface roughness.

Stable fluid films having sufficient load-carrying capacity are also achieved between parallel sliding surfaces by means of macro surface structures or micro surface structures of different types. These include, by way of example, waviness, and protruding micro-asperities. A good literature review on the subject can be found in Rodkiewicz C. M. and Sinha P., “On The Lubrication Theory—A Mechanism Responsible for Generation of the Parallel Bearing Load-Capacity”, Trans. ASME, Journal of Tribology (1993), 115, pp. 584-590. Inlet roughening by longitudinal or transverse grooves has been suggested for providing load capacity in parallel sliding. The inlet roughness concept is based on an “effective clearance” reduction in the sliding direction.

Generally speaking, the various prior-art approaches for providing load capacity in parallel sliding are of theoretical value, but are of limited practical applicability. On a practical level, it would be highly advantageous to have a thrust bearing for parallel sliding applications that is characterized by simplicity of design, ease of fabrication, superior hydrodynamic lift and reduced wear, reliability and economy.

In the field of seal technology, laser surface texturing (LST) is used for generating hydrodynamic lift in mechanical seals. U.S. Pat. No. 5,952,080 to Etsion, et al., discloses a method for designing bearings, of improved performance, the load-bearing surfaces of which feature micropores. The hydrodynamic pressure distribution of a suite of bearing surfaces with different micropore geometries and densities is modeled numerically. The load-bearing surfaces of the bearings are fabricated with micropores having the optima density and geometry determined by the numerical modeling. Substantially conical micropores may be created by single laser pulses, with the pore size and shape controlled by controlling the laser beam profile, the laser beam power, and the optical parameters of the focusing system.

A micro-surface structure in the form of micropores has several advantages over other micro-surface structures, particularly those involving protruding structures, in moving load-bearing surfaces. These advantages include:
1. Ease of manufacturing;
2. The ability to optimize pore size, shape, and distribution using theoretical models;
3. Good sealing capability in stationary (static) conditions, and
4. Providing micro-reservoirs for lubricant under starved lubrication conditions, for example, at startup and after lubricant loss.

Hence, laser texturing of parallel sliding surfaces offers a simple and practical design. The texturing process is extremely fast, and provides excellent control of the shape and size of the dimples so as to enable the realization of optimal, pre-determined parameters. Laser texturing processes are also environmentally friendly.

U.S. Pat. No. 6,341,782 to Etsion discloses a lubricated hydrostatic seal having (a) surface regions having opposing surfaces; (b) a plurality of micropores in one or more of the surfaces; and (c) a pressure-induced flow of fluid between the surfaces, wherein the flow of fluid past the micropores provides a lifting force between the surfaces. Preferably, the opposing surfaces of the surface regions are nominally parallel. Such surfaces are simple to manufacture and are considerably less expensive than the various known converging-surface or stepped configurations. The nominally-parallel surface configuration can also be utilized in both liquid-lubricated and gas-lubricated hydrodynamic seal applications, and in hybrid-seal applications in which both hydrodynamic and hydrostatic lift are generated.

Two different LST concepts are taught by U.S. Pat. Nos. 5,952,080 and 6,341,782 to Etsion, both of which could potentially be used to produce load carrying capacity in parallel sliding applications:
(1) a full width LST that is based on an individual dimple effect, i.e., local cavitation in each dimple, and
(2) a partial LST that is based on a “collective effect” of the dimples, i.e., the average clearance, converging in the direction of the velocity or pressure gradient.
   It might appear from the above-mentioned U.S. patents that a lifting technology that is effective in mechanical seals would necessarily be suitable for supplying the lifting force for bearings, as in thrust bearings for parallel sliding applications. U.S. Pat. No. 5,952,080 notes that
Although the load bearing surfaces modeled herein are referred to as “seal rings”, it is to be understood that the method of the present invention applies to load bearing surfaces generally, not just to seal rings. Furthermore, the term “bearing” as used herein includes all systems with surfaces in contact that bear loads and move relative to each other, for example reciprocating systems such as pistons in cylinders, and not just bearings per se.
   Similarly, U.S. Pat. No. 6,341,782 defines the term “seal” to include all systems with surfaces in contact that bear loads, including bearings.

However, although both seals and bearings have load-bearing surfaces, it will be appreciated that the functions of seals and bearings—and hence the respective performance criteria resulting therefrom—are markedly different. The main function of a seal is to seal, i.e., to join to systems or elements so as to inhibit leakage. The load-bearing surfaces of the seal are designed to extend the life of the seal by reducing friction, which in turn reduces both the mechanical wear and heat generation.

Bearings, on the other hand, are designed to bear a load. Consequently, bearing performance is generally determined, first and foremost, by the clearance achieved for a nominal load. Achieving maximal clearance is functionally at odds with seal design, because seals need a minimal clearance for sealing to be achieved.

Hence, the efficacy of laser-texturing in seal applications is by no means a proof of the efficacy of laser-texturing in bearings such as parallel thrust bearings.

Moreover, there exist a plethora of parameters that influence the load carrying capacity of parallel sliders. These parameters, provided in dimensionless form, include:

| | |
|---|---|
| Dimensionless treated portion of the slider: | α |
| Dimple aspect ratio: | ε |
| Dimensionless clearance: | δ |
| Cell aspect ratio: | κ |
| Area density of the dimples: | Sₚ |
| Slider length over width ratio: | L/B |
| Dimensionless slider width: | B |

Hence, even if it were known that LST may be potentially appropriate for thrust bearing applications, it would certainly be beyond the realm of one of ordinary skill in the art to design a functional, practicable thrust bearing, a design that must take into account, inter alia, various physical properties of the individual micropore, the position and area density of the micropores on the bearing surface(s), and the duty and dimensions of the bearing.

It would thus be highly advantageous to have a parallel thrust bearing that is based on, or enhanced with, micropore technology, such that the known features of micropore-based hydrodynamic seals—simple design, ease of fabrication, superior hydrodynamic lift and reduced wear, reliability and economy—could be imparted to parallel thrust bearings.

### SUMMARY OF THE INVENTION

According to the teachings of the present invention there is provided, a fluid-film bearing including: (a) a first surface region having a first bearing surface, for attaching to a first machine component; (b) a second surface region having a second bearing surface, for attaching to a second machine component; the surface regions designed and configured such that the first surface and the second surface are disposed opposite one another, the surface regions further designed and configured such that the first surface and the second surface move in a relative motion with respect to one another, and (c) a fluid disposed between the surfaces, wherein at least one of the surfaces is a micropore-containing surface having a plurality of micropores disposed so as to effect an equivalent clearance convergence between the surfaces, in a direction of the relative motion, such that the relative motion, acting on the fluid, generates a pressure so as to generate a lifting force between the surfaces.

According to further features in the described preferred embodiments, the micropore-containing surface is parameterized by a width B* in the direction of the relative motion, and a length L*, and wherein L*/B* exceeds 0.2, preferably exceeds 0.3, more preferably exceeds 0.5, still more preferably exceeds 0.7, and most preferably exceeds 1.0.

According to still further features in the described preferred embodiments, the surfaces are nominally parallel.

According to still further features in the described preferred embodiments, a parameter α defines a ratio of surface area textured with the micropores to a total bearing surface area of the micropore-containing surface, α having a value between about 0.2 and about 0.9. Preferably, α has a value between about 0.3 and about 0.8, and most preferably, α has a value between about 0.5 and about 0.7.

According to still further features in the described preferred embodiments, a parameter Sₚ defines an area density of the micropores on the micropore-containing surface, Sₚ having a value exceeding about 0.2, preferably exceeding about 0.4, and most preferably exceeding about 0.5.

According to still further features in the described preferred embodiments, a parameter hₚ is a dimensionless dimple depth defined by:
hₚ=hₚ*/h₀*
wherein hₚ* is a characteristic dimple depth of the micropores, and h₀* is a minimum clearance between the surfaces, and wherein hₚ exceeds about 0.5, preferably exceeds about 0.6, and most preferably exceeds about 0.75.

According to still further features in the described preferred embodiments, the relative motion is bidirectional, and wherein the micropore-containing surface includes a first area and a second area, the first area disposed so as to effect an equivalent clearance convergence between the surfaces in a first direction of the relative motion, and the second area disposed so as to effect an equivalent clearance convergence between the surfaces in a second direction of the relative motion.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 is a schematic illustration of a parallel thrust bearing;

FIG. 2 is a model of a slider including a surface having a partial laser texturing;

FIG. 3 is a schematic cross-sectional view of a parallel slider including a surface having a partial laser texturing;

FIG. 4 is a schematic illustration of a single column of dimples in an infinitely long slider, and the boundary conditions thereof;

FIG. 5 is a graphical illustration showing typical distributions of local pressure for partial and full texturing (B=25, hₚ=1.3);

FIG. 6 is a graphical illustration showing the effect of the textured portion (a) on the dimensionless load-carrying capacity of an infinitely-long parallel slider at various dimensionless dimple depths (hₚ);

FIG. 7 is a graphical illustration showing the effect of the dimensionless dimple depth (hₚ) on the dimensionless load-carrying capacity of an infinitely long parallel slider having an optimal value of the textured portion (α=0.6), and various dimple area densities (Sₚ);

FIG. 8 is a graphical illustration showing the effect of the dimple area density (Sₚ) on the dimensionless load-carrying capacity of an infinitely-long parallel slider having an optimal value of the textured portion (α=0.6), and various dimensionless dimple depths (hₚ);

FIG. 9 is a schematic illustration of a typical pressure distributions in each of three slider bearing configurations of: 1—plane slider, 2—stepped slider, 3—surface textured parallel slider;

FIG. 10 is a graphical illustration showing the effect of the slider aspect ratio (L/B) on the optimal value of the textured portion (αₒₚₜ) for maximum load-carrying capacity of finite parallel sliders;

FIG. 11 is a graphical illustration showing the effects of the textured portion (α) and the slider aspect ratio (L/B) on the dimensionless load-carrying capacity of finite parallel sliders;

FIG. 12 (a) and (b) are schematic illustrations of a stator for a uni-directional bearing, the stator having pads including a micropore-containing (LST) surface, wherein FIG. 12(a) is a cross-sectional view, and FIG. 12(b) is a top view;

FIG. 12 (c) and (d) are schematic illustrations of a stator for a bi-directional bearing, the stator having pads including a micropore-containing (LST) surface, wherein FIG. 12(c) is a cross-sectional view, and FIG. 12(d) is a top view;

FIG. 13 is a schematic illustration of the test rig;

FIG. 14 is a graphical comparison of the theoretical and experimental results of the bearing clearance as a function of the load at 1500 and 3000 rpm.

FIG. 15 is a graphical comparison of the clearance as a function of the load performance of a partial LST uni-directional bearing vs. an untextured bearing;

FIG. 16 is a graphical comparison of the clearance as a function of the load performance of a partial LST vs. an untextured bidirectional bearing, and

FIG. 17 is a graphical comparison of the friction coefficient of the partial LST bearing vs. the friction coefficient of an untextured bearing, the bearings operating at 1500 rpm.

### DESCRIPTION OF THE PREFERRED EMBODIMENTS

The principles and operation of the laser surface textured parallel thrust bearing according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

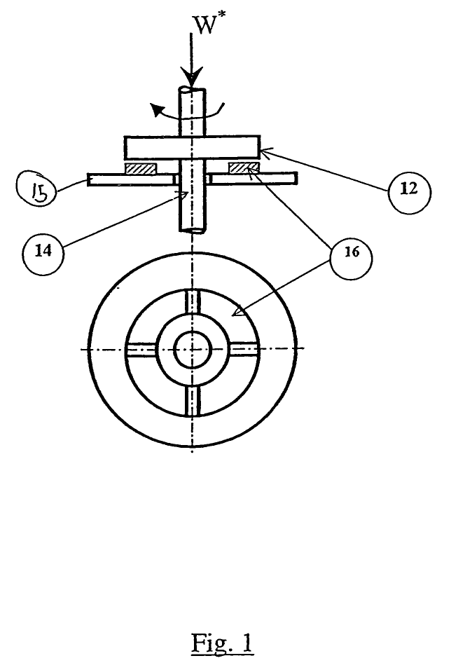

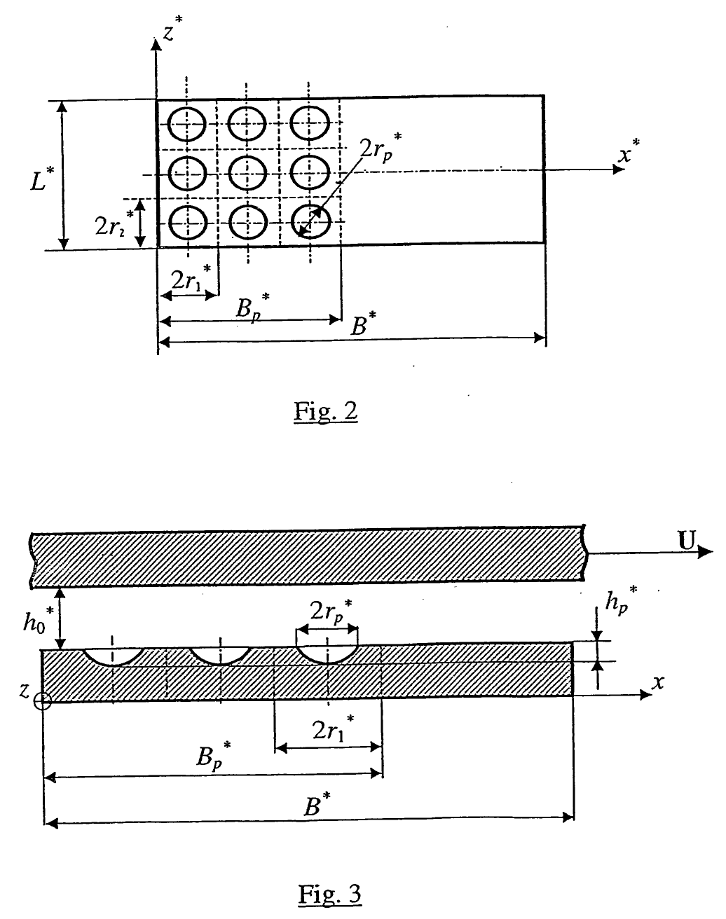

A schematic representation of a parallel thrust bearing is provided in FIG. 1. A plain rotating disk (or rotor) 12 rotates about an axis 14 relative to a number of identical stationary pads disposed on a fixed disk (or stator) 15. Each pad 16, when properly textured, develops the same hydrodynamic force. Hence, in order to evaluate the load-carrying capacity of the complete parallel thrust bearing, it is sufficient to determine the hydrodynamic pressure distribution over a single pad 16. A simplified geometrical model of a single pad in the form of a rectangular parallel slider is displayed in FIG. 2. A schematic cross-sectional view of such a slider, including a surface having a partial laser texturing, is provided in FIG. 3.

The dimples are regularly distributed over a portion, 0≦α≦1, of the slider width, B*, in the sliding direction, x*, and over the full slider length, L*, as shown in FIG. 2. Each dimple is modeled by a spherical segment having a base radius rₚ* and depth hₚ*, and is located in the center of an imaginary rectangular cell of sides 2r*₁×2r*₂. The dimensionless parameter κ=r*₂/r*₁, characterizes the cell shape, and the area density of dimples is given by Sₚ=(πr*hd p²/4κr*hd 1²).

The two-dimensional, steady state form of the Reynolds equation for an incompressible Newtonian fluid in a laminar flow is given by:

$$\frac{\partial }{\partial {x}^{*}} ( {h}^{{*}^{3}} \frac{\partial {p}^{*}}{\partial {x}^{*}} ) + \frac{\partial }{\partial {z}^{*}} ( {h}^{{*}^{3}} \frac{\partial {p}^{*}}{\partial {z}^{*}} ) = 6 μ U \frac{\partial {h}^{*}}{\partial {x}^{*}} \qquad [ 1 ]$$

where x* and z* are the Cartesian coordinates, parallel and normal to the sliding direction, respectively, and h* and p* are the local film thickness and the pressure at a specific point of the slider, respectively.

In order to reduce Eq. [1] to a dimensionless form, the dimensionless coordinates x and z, dimensionless local film thickness, h, and dimensionless local pressure, p, are defined as follows:

$$x = \frac{{x}^{*}}{{r}_{p}^{*}} ; z = \frac{{z}^{*}}{{r}_{p}^{*}} ; h = \frac{{h}^{*}}{{h}_{0}^{*}} ; p = \frac{1}{Λ} ( \frac{{p}^{*}}{{p}_{a}^{*}} - 1 ) \qquad [ 2 ]$$

where p*_{α} is the ambient pressure, h*₀ is the bearing clearance (see FIG. 3) and Λ is the dimensionless bearing number, given as:

$$Λ = \frac{3 μ U}{2 {r}_{p}^{*} {p}_{a}^{*}} \qquad [ 3 ]$$

Substituting Eqs. [2] and [3] into [1] yields the Reynolds equation in dimensionless form:

$$\frac{\partial }{\partial x} ( {h}^{3} \frac{\partial p}{\partial x} ) + \frac{\partial }{\partial z} ( {h}^{3} \frac{\partial p}{\partial x} ) = \frac{1}{{δ}^{2}} \frac{\partial h}{\partial x} \qquad [ 4 ]$$

where δ is the dimensionless clearance, defined as:

$$δ = \frac{{h}_{0}^{*}}{2 {r}_{p}^{*}} \qquad [ 5 ]$$

By specifying the film thickness distribution h(x,z) and the relevant boundary conditions, the Reynolds equation [4] can be solved for the pressure distribution in the lubricating film. Integrating this pressure over the slider area yields the hydrodynamic force acting in the axial direction on one pad.

Based on the assumption of spherical dimples the dimensionless film thickness at a specific point of the textured surface is given by:

$$h = 1 + \sqrt{( \frac{{h}_{p}}{2} + \frac{1}{8 {h}_{p} {δ}^{2}} ) - \frac{1}{4 {δ}^{2}} ( {x}_{l}^{2} + {z}_{l}^{2} )} - ( \frac{1}{8 {h}_{p} {δ}^{2}} - \frac{{h}_{p}}{2} ) for {x}_{l}^{2} + {z}_{l}^{2} \leq 1 ; \\ and \\ h = 1 for {x}_{l}^{2} + {z}_{l}^{2} > 1 , \qquad [ 6 ]$$

where x₁, z₁ are local dimensionless coordinates with their origin at the center of a single dimple cell, given by:

$${x}_{l} = \frac{{x}_{l}^{*}}{{r}_{p}^{*}} ; {z}_{l} = \frac{{z}_{l}^{*}}{{r}_{p}^{*}} \qquad [ 7 ]$$

The pressure along the slider boundaries is equal to the ambient pressure p*_{α} that, according to the definitions in [2], corresponds to zero dimensionless pressure. In the subsequent analysis the following boundary conditions will be used (see FIG. 2):
p(0, z)=p(B, z)=p(x,−L/2)=p(x, L/2)=0 [8]

The boundary conditions [8] should be complemented by the conditions at the boundaries of possible cavitation regions associated with each individual dimple. In the present work, the Reynolds condition (also known as the Swift-Stieber or continuity boundary condition) implies that on the boundary of the cavitation zone, the pressure gradient with respect to the direction normal to the boundary is zero and the dimensionless pressure inside the cavitation zone is fixed at zero. Using an iterative solution, it is simple to apply this condition to the Reynolds Equation [4]. If negative (sub-ambient) pressures are changed to zero in each iterative cycle, the process converges, by numerical diffusion, to the required Reynolds condition.

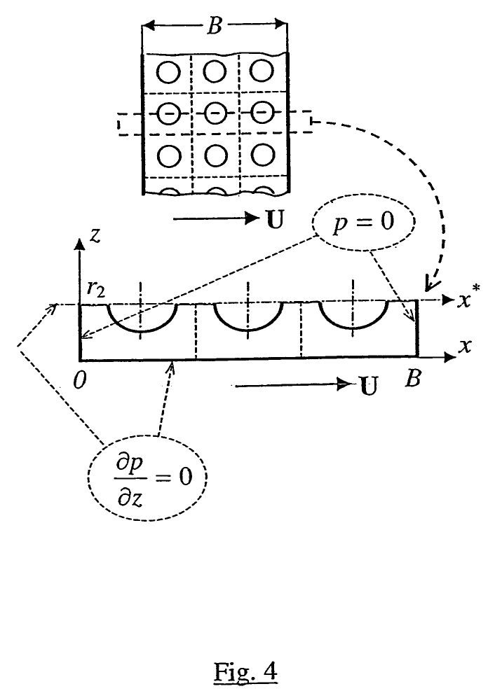

The presented analytical model is valid for all values of slider length, L, and width, B. However, if the slider is long enough in the z direction (normal to the sliding velocity), with a ratio L*/B*>4, the end effects in this direction can be neglected. In this special case, the pressure distribution is periodical in the z direction with a period equal to the imaginary cell size 2r₂. Hence, because of this periodicity, it is sufficient to consider a single column of dimples along the x direction. Due to the symmetry of the dimples column about the x* axis (see FIG. 4), the pressure distribution will be also symmetric about this axis. Therefore, to obtain the complete pressure distribution, it is sufficient to consider only one half of the dimples column with z varying from 0 to r₂ (see FIG. 4). From the periodicity, symmetry and continuity of the pressure distribution, it follows that:

$$\frac{\partial p}{\partial z} ( x , 0 ) = \frac{\partial p}{\partial z} ( x , {r}_{2} ) = 0 \qquad [ 9 ]$$

The Reynolds equation [4] with its appropriate boundary conditions, [8] for a finite or, for an infinitely long slider [9], was solved by a finite differences method using a non-uniform grid over the imaginary dimple cell, with a denser mesh within the dimpled area (about five times denser than outside the dimpled region). Discretization of the Reynolds equation, using finite differences, leads to a set of linear algebraic equations for the nodal values of the pressure. These equations were solved using a known, successive over-relaxation Gauss-Seidel iterative method. Although the iterative algorithm of Gauss-Seidel is not always the most effective one, it is convenient for evaluation of the pressure distribution with previously unknown cavitation zones.

Following completion of the iterative solution, the dimensionless pressure p(x,z) is numerically integrated over the slider area, yielding the dimensionless load-carrying capacity:

$$\overline{W} = 2 {\int }_{0}^{B} ( {\int }_{0}^{L / 2} p ⅆ z ) ⅆ x \qquad [ 10 ]$$

In the case of the “infinitely long” slider, the dimensionless load-carrying capacity is given by:

$$\overline{W} = \frac{L}{{r}_{2}} {\int }_{0}^{B} ( {\int }_{0}^{{r}_{2}} p ⅆ z ) ⅆ x \qquad [ 11 ]$$

where, by Eqs. [2] and [3], \overline{W} is related to the dimensional load-carrying capacity W* in the form:

$$\overline{W} = \frac{2 {W}^{*}}{3 μ {Ur}_{p}^{*}} \qquad [ 12 ]$$

In the hydrodynamic lubrication literature, the dimensional load-carrying capacity W* is usually normalized in the form:

$$W = \frac{{W}^{*} {h}_{0}^{* 2}}{μ {UL}^{*} {B}^{* 2}} \qquad [ 13 ]$$

Hence, by Eqs. [12] and [13], the relation between the two dimensionless load carrying capacity forms W and \overline{W} is:

$$W = \frac{6 {δ}^{2}}{{LB}^{2}} \overline{W} \qquad [ 14 ]$$

Once the equations were developed, a parametric analysis was performed to investigate the effect of the relevant dimensionless parameters on the load-carrying capacity of parallel sliders. These parameters, and the range in which they were varied, include:

| | |
|---|---|
| Dimensionless treated portion of the slider: | 0 ≦ α ≦ 1 |
| Dimple aspect ratio: | 0 < ε ≦ 0.25 |
| Dimensionless clearance: | 0.02 ≦ δ ≦ 0.5 |
| Cell aspect ratio: | 0.4 ≦ κ ≦ 1 |
| Area density of the dimples: | 0 < Sₚ ≦ 0.8 |
| Slider length over width ratio: | 0.1 ≦ L/B < ∞ |
| Dimensionless slider width: | 25 ≦ B ≦ 200 |

From a large number of numerical simulations, I found that the cell aspect ratio (κ) has an adverse effect on load capacity for κ greater than 1, hence, the analysis was restricted to κ≦1. In this range, I found that κ has a negligible effect on the load carrying capacity. Therefore, a typical value of this parameter κ=1 (a square dimple cell) was selected. Similarly, I found that increasing the parameter B above the value of B=50 has a negligible effect on W and hence, to save computing time and focus on more sensitive parameters, the value B=50 was selected as representing the whole range of width for practical sliders. After investigating the parameter δ, I found that δ has very little effect on the dimensionless load-carrying capacity. The parameters that I found to be most important in affecting the load-carrying capacity are: L/B, which characterizes the slider geometry, and the parameters α, hₚ, and Sₚ, which characterize the surface texturing. The definition of hₚ, the dimensionless dimple depth, is the dimple depth divided by the minimum clearance of the bearing.

Two different effects of the dimples were discovered, corresponding to the cases of partial texturing, α<1, and full texturing, α=1. In the case of partial texturing, no optimum of the dimple area density Sₚ was observed. In this case, the load-carrying capacity increases with increasing area density of the dimples. This conforms to known theory, since the limiting case Sₚ=1 corresponds to a step slider, which is the optimum known geometry for a slider bearing. In the case of full texturing, there exists an optimal value of the area density of the dimples. The optimal value was found to be Sₚ=0.13.

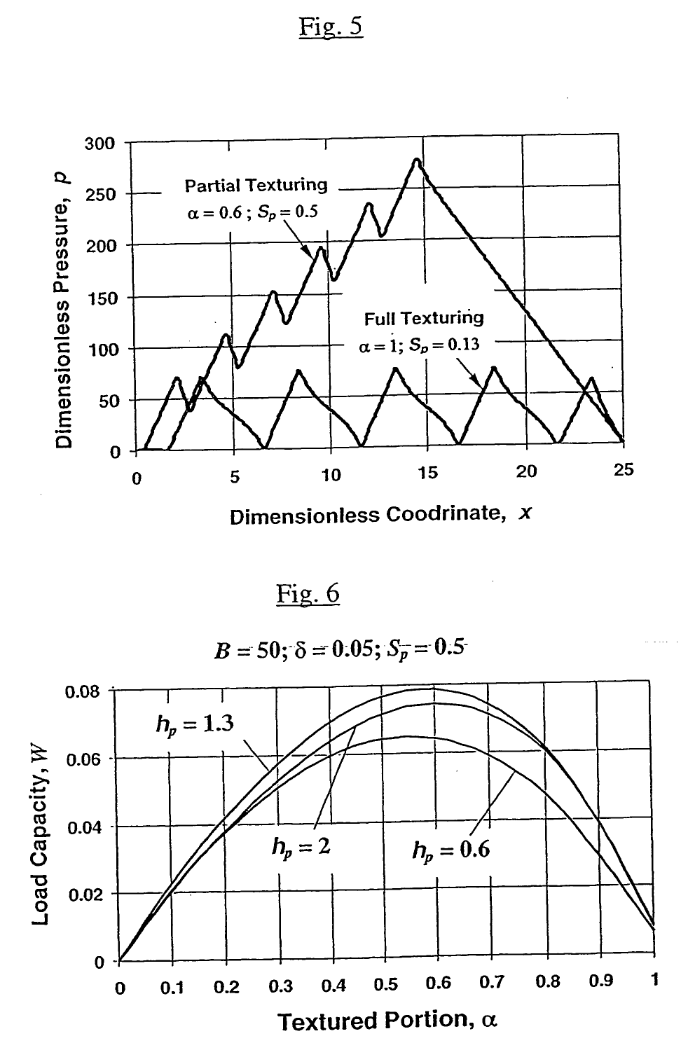

The above two different effects are demonstrated in FIG. 5, which shows typical distributions of the local pressure along the center-line of a single column of dimples for the two cases of partial (α=0.6) and full (α=1) texturing. The results in FIG. 5 were obtained for an infinitely long slider having a dimensionless width (B) of 25 and a dimensionless dimple depth (hₚ) of 1.3. The dimples in the partial texturing case have an area density Sₚ=0.5 and, as is clearly seen from proximity of the dimples, neighboring dimples strongly affect one another (“collective dimples effect”). The collective effect results in a step-like pressure distribution over the textured portion of the slider with a maximum dimensionless pressure p=275 at x=Bₚ32 15 corresponding to α=0.6. The dimples in the full texturing case do not interact (an individual dimple effect), resulting in a periodic pressure distribution with local cavitation zones (p=0). The optimum area density of the dimples in this case for maximum pressure and load capacity was Sₚ=0.13 and the maximum local pressure in this case is p=75.

I further discovered that infinitely long sliders behave in a characteristically different fashion with respect to finite sliders, as will be forthcoming from the development provided hereinbelow.

Infinitely-Long Slider

A typical case of an infinitely long slider was selected to demonstrate the effect of the various important texturing parameters on the load-carrying capacity. FIG. 6 presents the effect of the textured portion (α) at different values of dimensionless dimple depth (hₚ). A dimple area density (Sₚ) of 0.5 was selected for this case. Such a dimple area density is high enough to produce a substantial load-carrying capacity, yet is also practicable, using LST, in that the overlapping of dimples can be avoided. FIG. 6 graphically illustrates a zero load-carrying capacity for α=0, as would be expected with a non-textured parallel slider. At α=1 (fully-textured slider), a certain load-carrying capacity exists (due to the individual dimple effect), but this capacity is quite low.

An important, surprising finding is the existence of a distinct optimum at α=0.6 and hₚ=1.3 that maximizes the load-carrying capacity. As can be seen in FIG. 6, this maximum load-carrying capacity is an order of magnitude higher than the load capacity for α=1. Hence, for infinitely long sliders it is clearly preferable to use the collective dimple effect, and not the individual one. This finding, which was subsequently corroborated experimentally, manifestly demonstrates that the performance of laser-texturing in mechanical seal applications—in which the individual dimple effect is extremely effective—is by no means a proof of the efficacy of laser-texturing in bearing (e.g., parallel thrust bearings) applications—in which the individual dimple effect provides a poor load-carrying capacity.

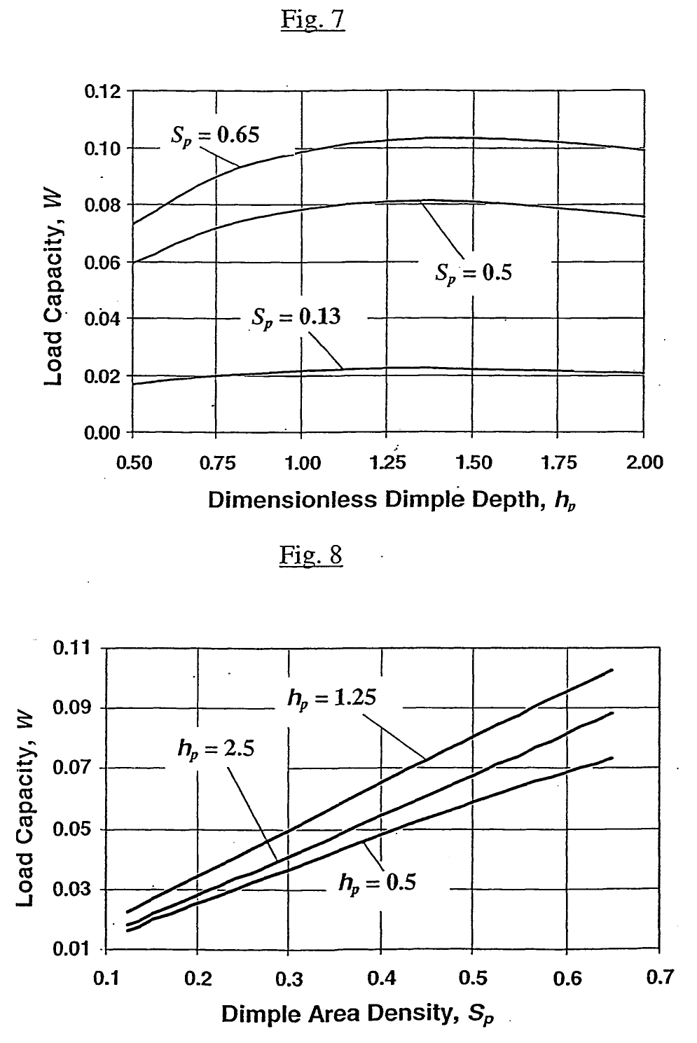

FIG. 7 is a graphical illustration showing the effect of the dimensionless dimple depth (hₚ) on the dimensionless load-carrying capacity (W) of an infinitely-long parallel slider having an optimal value of the textured portion (α=0.6), and various dimple area densities (Sₚ). An optimum for hₚ exists in the range 0.5≦hₚ≦2, and is almost independent of Sₚ. This optimum is close to hₚ=1.3, however, it is very weak, such that in the range of values 1≦hₚ≦2, the load-carrying capacity at a given Sₚ is nearly constant.

FIG. 8 is a graphical illustration showing the effect of the dimple area density (Sₚ) on the dimensionless load-carrying capacity of an infinitely-long parallel slider having an optimal value of the textured portion (α=0.6), and various dimensionless dimple depths (hₚ). The load-carrying capacity is nearly proportional to the area density of the dimples, Sₚ. In fact, the maximum load-carrying capacity is obtained with the maximum possible area density. Hence, it can be concluded that at α=0.6, the textured infinitely-long slider behaves in the same manner as a step slider. Using FIG. 8 (for hₚ=1.25) yields an empirical relation for the best load-carrying capacity of an infinitely-long textured slider:
W=0.16Sₚ [15]
Equation [15] is valid in the range of textured portion cc from 0.5 to 0.65, dimensionless dimple depth hₚ from 1 to 2, and dimple density 0.4<Sₚ<0.8:

A comparison of the optimal parameters and corresponding maximum load-carrying capacity of an infinitely long, textured parallel slider with plane and stepped sliders (see O. Pinkcus, and B. Sternlicht, Theory of Hydrodynamic Lubrication, McGraw-Hill Inc., New York (1961)) is presented in Table 1. It is evident that the optimal parameters and load capacities of all these sliders are similar. It is observed that for the surface textured slider with optimum dimple depth hₚ, the optimum “effective” clearance ratio is:
(hᵢ*/h₀*)=1+hₚ.

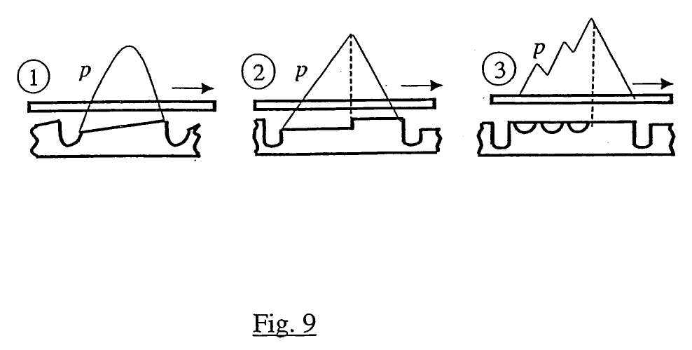

It is further observed that at Sₚ=0.64, the load-carrying capacity of a parallel textured slider is reaches 0.5 of that for the optimal step slider. The typical pressure distributions for the three slider geometries of Table 1 are provided in FIG. 9. As can be seen from FIG. 9, the pressure behavior in cases 2 and 3 is similar: both have a maximum at the step, or at the end of the textured portion, followed by a linear drop to the slider end. In the case of the surface-textured parallel slider, local pressure oscillations exist over the textured portion due to local convergence—divergence of the clearance at the dimples. The characteristic similarities between the pressure distributions shown in FIG. 9 indicate that the partial LST of an infinitely-long parallel slider provides the same source for the load-carrying capacity as with the other two geometries, namely, average clearance converging in the sliding direction.

TABLE 1

| | | | Surface-Textured |
|---|---|---|---|
| Parameters | Step Slider | Plane Slider | Slider |
| (h₁^{*} / h₀^{*}ₒₚₜ | 1.87 | 2.2 | 2.3 |
| αₒₚₜ | 0.72 | — | 0.6 |
| Wₘₐₓ | 0.205 | 0.16 | 0.16 Sₚ |
| Wₘₐₓ/Wₘₐₓ^{step} | 1 | 0.78 | 0.78 Sₚ |

Finite Slider

A wide range of L/B ratios was investigated for the case of a finite slider. An optimum value of hₚ=1.25 was found for the maximum load-carrying capacity. This optimum value, as in the case of the infinitely-long slider, is weak and, in the range of 1≦hₚ≦1.5, the load-carrying capacity is almost constant.

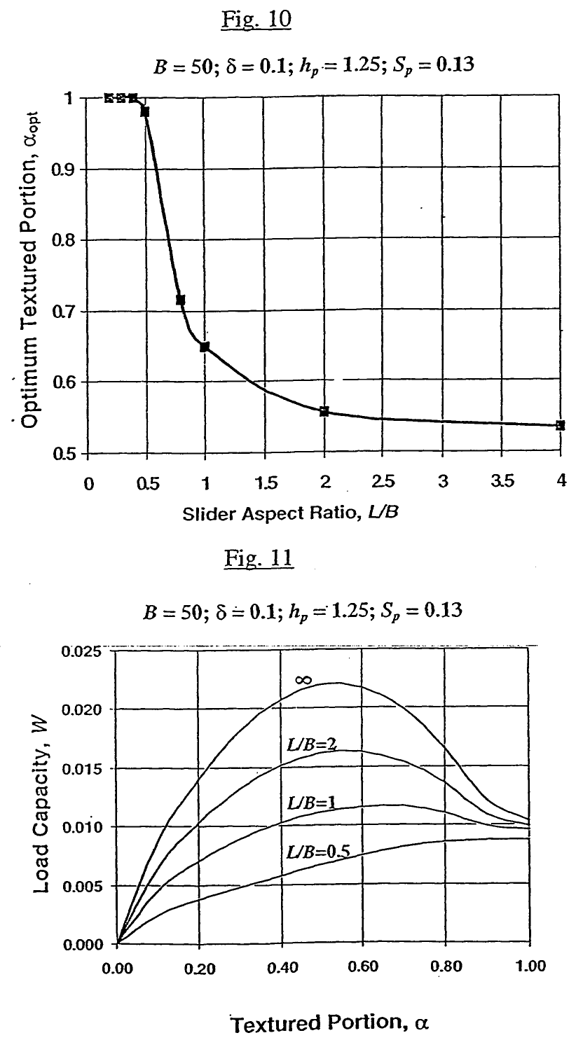

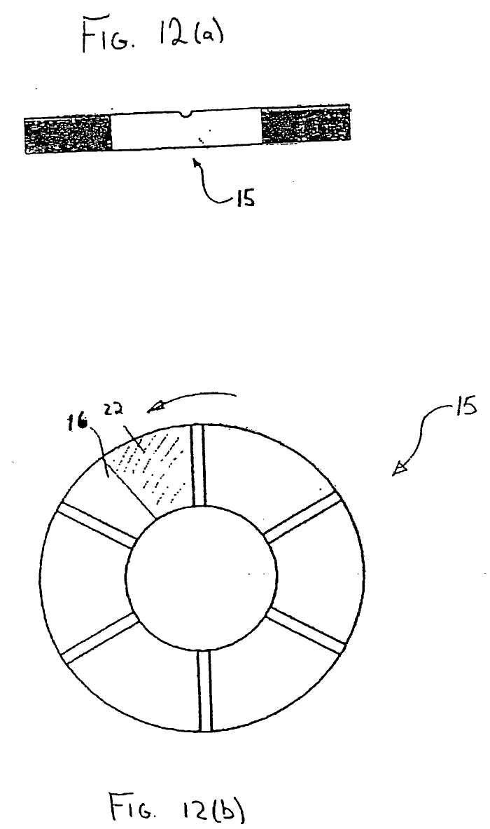

Another important and surprising finding is that, contrary to the long slider case, for L/B≦0.5, it is better to texture the full width (α=1) of the slider rather than just a portion of it (α<1). In this case, the optimal dimple density is Sₚ=0.13 and the individual dimple effect with local cavitation is dominant. As the ratio LIB increases above 0.5, the optimum value of α drops sharply, and at about L/B=1.5, α attains the optimal value of about 0.6 that is characteristic of long sliders. The relation between optimal α values and the ratio L/B is provided graphically in FIG. 10 for hₚ=1.25 and Sₚ=0.13. This area density, which is the optimum for L/B<0.5 (whenever αₒₚₜ=1), was maintained as a common basis for comparison throughout the L/B range, although it is not the best for L/B>0.5. The differences, however are relatively small, and at L/B=2 and Sₚ=0.5, for example, the optimal value is αₒₚₜ=0.58, as opposed to αₒₚₜ=0.54 for Sₚ=0.13.

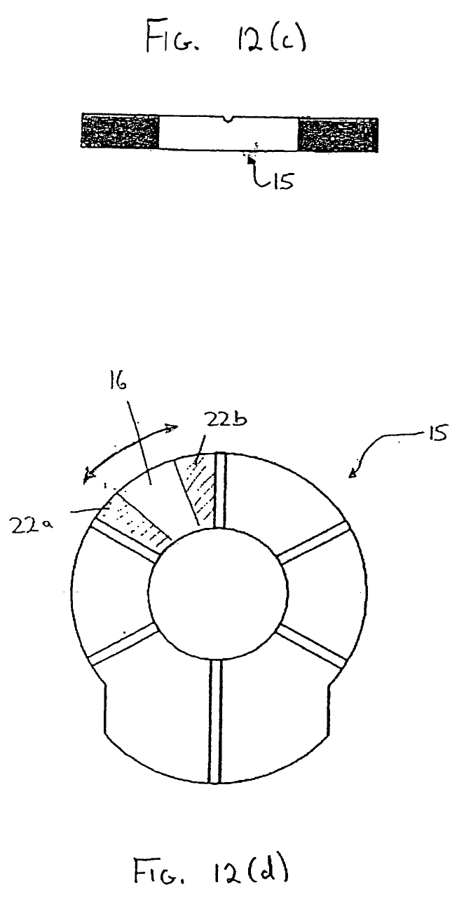

Reducing the ratio L/B has a pronounced effect on the load-carrying capacity, as is evident from the graphical representation provided in FIG. 11. The A dimple area density (Sₚ) of Sₚ=0.13 was selected, once again, as a common basis for comparison to allow inclusion of the full LST case with α=1. It must be stressed, however, that higher loads could be obtained with partial LST (α<1) at higher Sₚ values for L/B>1. FIG. 11 shows a substantial reduction of the load-carrying capacity with diminishing L/B ratio over the whole range of α. This reduction is more pronounced for at between 0.5 and 0.6. The reason for the reduced load capacity is the increasing side leakage in short sliders, which prevents buildup of high hydrodynamic pressure and suppresses the “collective effect” in partial LST. It is observed from FIG. 11 that the “individual effect” (local cavitation) in the case of full LST (α=1) is almost unaffected by the leakage, and sliders with substantially different L/B values have very similar load capacities. Note the gradual increase of the optimal α value for maximum W as L/B decreases from infinite to L/B=1. At an L/B ratio equal or lower than 0.5, the maximum load-carrying capacity corresponds to the value of α=1. In this case the optimum dimple area density (Sₚ) is 0.13.

The potential of laser surface texturing in the form of regular micro-dimples for providing load carrying capacity with parallel thrust bearings was demonstrated.

A model of a textured parallel slider was developed and the effect of surface texturing on load carrying capacity was analyzed. The optimum parameters of the dimples were found in order to obtain maximum load carrying capacity. Two physical mechanisms for generating hydrodynamic pressure in a parallel thrust bearing with textured surfaces were presented.
1. The micro-dimple “individual effect”, which corresponds to full width texturing (α=1) and is not useful for developing the large load-carrying capacity expected from a hydrodynamic thrust bearing. It can, however, be beneficial in very short slider bearings, as is the case of mechanical seals, for example. The optimal area density of the dimples in this case was found to be Sₚ=0.13.
2. The micro-dimple “collective effect”, which corresponds to partial width texturing (α<1), is capable of generating substantial load carrying capacity, approaching that of optimal conventional thrust bearings. This effect is useful in finite and long sliders having a ratio of L/B≧1. In this case, the optimal α value is about 0.6 and the maximum dimensionless load-carrying capacity is W=0.16Sₚ. Hence, the maximum practical density that can be produced by the laser texturing is desired in this case.

Another important finding is that over the entire range of L/B ratios the dimple depth should be about the same as that of the film thickness for best performance of the bearing.

The validity of the above-described model was investigated experimentally. LST bearings were tested under a variety of conditions, and the performances attained were compared with the theoretical performances predicted by the model and with the performance of standard non-textured bearings.

The tested bearings consisted of sintered SiC disks 10 mm thick, having outer diameter of 85 mm and an inner diameter of 40 mm. Each bearing includes a flat rotor (a) and a six pads stator (b). The bearings were provided with an original surface finish by lapping to a roughness average R_{α}=0.03 μm. Each pad has an aspect ratio of 0.75 when the pad width is measured along the mean diameter of the stator.

Schematic diagrams of two partial LST stators are shown in FIGS. 12(a)-(d). FIGS. 12 (a) and (b) are schematic illustrations of a stator 15 for a uni-directional bearing, the stator having pads including a micropore-containing (LST) surface wherein FIG. 12(a) is a cross-sectional view, and FIG. 12(b) is a top view. FIGS. 12(c) and (d) correspond to FIGS. 12(a) and (b), for a bi-directional bearing.

In the uni-directional bearing (see FIG. 12(b)), each micropore-containing surface 22 is adjacent to the leading edge of each pad 16 (only one micropore-containing surface is shown). In the bi-directional bearing, each micropore-containing surface 22a,22b is adjacent to an end of pad 16 (see FIG. 12(d)).

For the experiments conducted, the laser texturing parameters were as follows:
dimple depth hₚ*=6.5±0.5 μm;
dimple diameter 2rₚ*=60±5 μm;
dimple area density Sₚ=0.6±0.03.
   These dimple dimensions were obtained with 4 pulses of 30 nsec duration and 4 mJ each using a 5KHz pulsating Nd:YAG laser. The textured portion of the unidirectional bearing (α) was 0.73 and that of the bi-directional bearing was 0.63. Based on the above-developed model, both these α values should produce a load-carrying capacity that is very close to the maximum theoretical value.

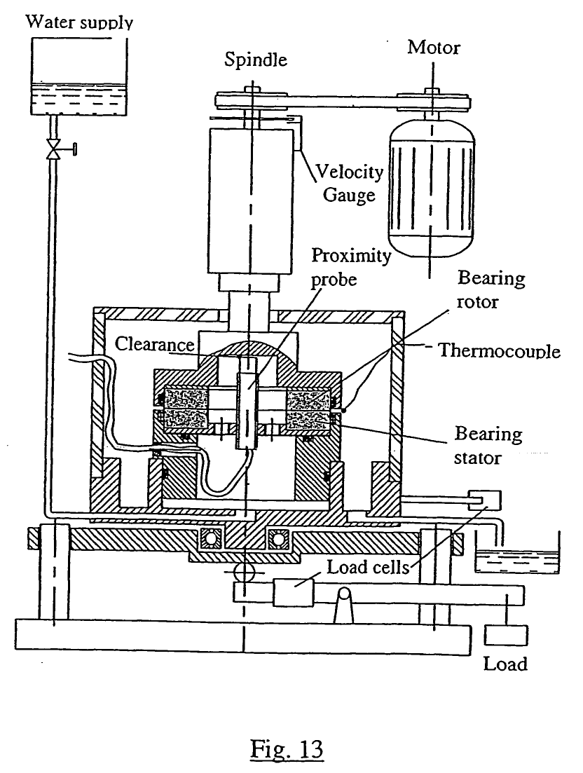

The test rig is shown schematically in FIG. 13. An electrical motor turns a spindle to which an upper holder of the rotor is attached. A second lower holder of the stator is fixed to a housing, which rests on a journal bearing and an axial loading mechanism that can freely move in the axial direction. An arm that presses against a load cell and thereby permits friction torque measurements prevents the free rotation of this housing. Axial loading is provided by means of dead weights on a leaver and is measured with a second load cell. A proximity probe that is attached to the lower holder of the stator allows on-line measurements of the clearance change between rotor and stator as the hydrodynamic effects cause axial movement of the housing to which the stator holder is fixed. Tap water is supplied by gravity from a large tank to the center of the bearing and the leakage from the bearing is collected and recirculated. A thermocouple adjacent to the outer diameter of the bearing allows monitoring of the water temperature as the water exit the bearing. A PC is used to collect and process data on-line hence, the instantaneous clearance, friction coefficient, bearing speed and exit water temperature can be monitored constantly.

The test protocol includes identifying a reference “zero” point for the clearance measurements by first loading and then unloading a stationary bearing over the full load range.

Subsequently, the lowest axial load is applied, the water supply valve is opened and the motor is turned on. Axial loading is increased by steps of 40 N, and each load step is maintained for 5 minutes following the stabilization of the friction coefficient at a steady state value. The bearing speed and water temperature are monitored throughout the test for irregularities. The test is concluded when a maximum axial load of 460 N is reached, or if the friction coefficient exceeds a value of 0.35. At the end of the last load step, the motor and water supply are turned off, and the reference for the clearance measurements is rechecked. Tests are performed at two speeds of 1500 and 3000 rpm, corresponding to average sliding velocities of 4.9 and 9.8 m/sec, respectively, and each test is repeated at least three times.

Results and Discussion

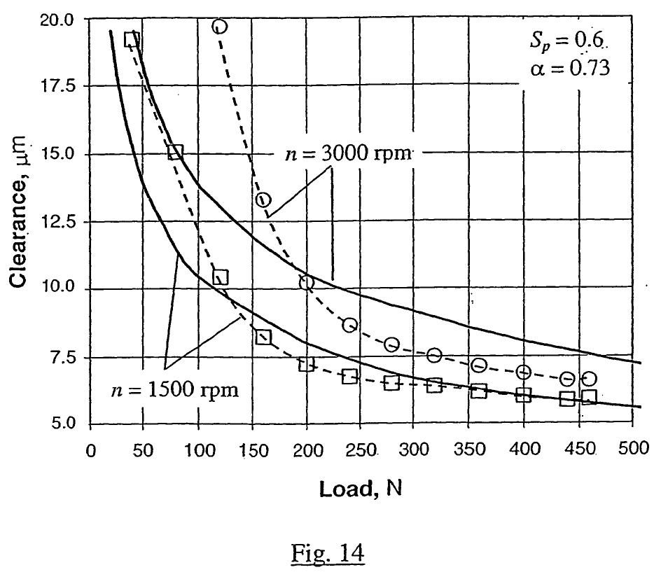

Initially, the validity of the theoretical model was examined by comparing the theoretical and experimental results of bearing clearance vs. bearing load for a unidirectional partial LST bearing. The results are shown in FIG. 14 for both 1500 and 3000 rpm, where the solid and dashed lines correspond to the model and experiment, respectively. As can be seen, the agreement between the model and the experiment is good with differences of less than 10percent for loads exceeding 150 N. At lower loads the measured experimental clearances are much larger than the model predictions, particularly at the higher speed of 3000 rpm, where at 120 N the measured clearance is 20 μm, which is about 60 percent higher than the predicted value. It turns out that the combination of such large clearances and the relatively low viscosity of the water may result in a turbulent fluid film, hence, the assumption of laminar flow, on which the solution of the Reynolds equation in my theoretical model is based, may be violated, making the model invalid under such conditions.

It should be noted that the first attempts to test the baseline untextured bearing with the original surface finish of R_{α}=0.03 μm on both the stator and rotor failed due to extremely high friction already at the lower loads. On the other hand the partial LST bearing run smoothly throughout the load range. It was found that the post LST lapping to completely remove about 2 μm height bulges, which are formed during texturing around the rims of the dimples, resulted in a slightly rougher surface with R_{α}=0.04 μm. Hence, the baseline untextured stator was also lapped to the same roughness of the partial LST stator and all subsequent tests were performed with the same R_{α} value of 0.04 μm for all the tested stators. The rotor surface roughness remained the original one i.e., 0.03 μm.

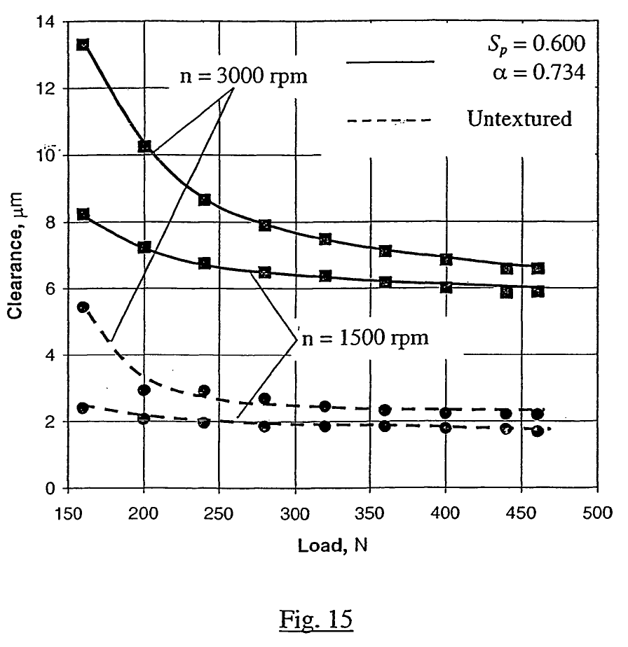

FIG. 15 provides a graphical comparison of the clearance vs. the load performance of a partial LST unidirectional bearing and a baseline untextured bearing. The comparison is made at rotor speeds of 1500 and 3000 rpm. The area density of the dimples in partial LST bearing (Sₚ) is 0.6 and the textured portion (α) is 0.734. The load range extends from 160 to 460 N. The upper load was constrained by the test rig, which does not permit a higher loading. It is evident from FIG. 15 that the partial LST bearing attains substantially larger clearances than the untextured bearing. At the maximum load of 460 N and at 1500 rpm, the partial LST bearing has a clearance of 6 μm, while the untextured bearing clearance is only 1.7 μm. At 3000 rpm, the clearances are 6.6 and 2.2 μm for the LST and untextured bearings, respectively. The ratio of about 3:1 in favor of the partial LST bearing is maintained over the entire load range.

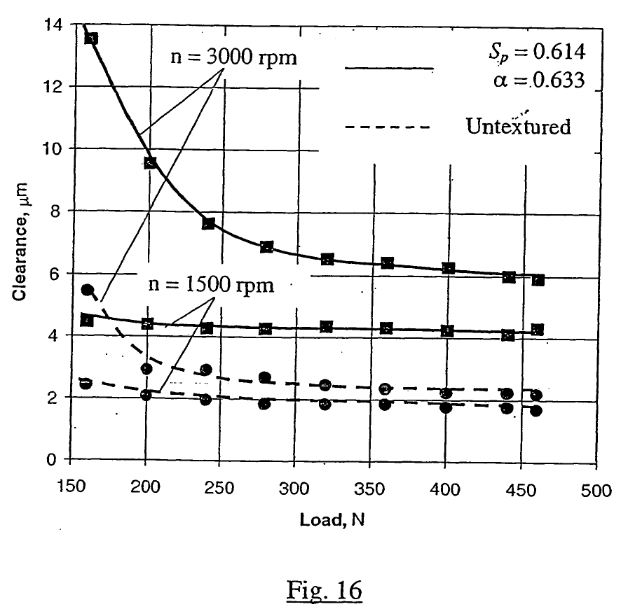

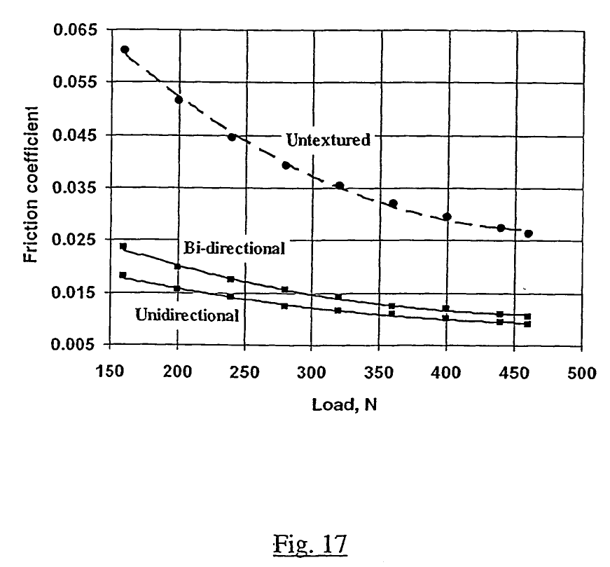

FIG. 16 provides a graphical comparison of the results for the bidirectional bearing (shown in FIG. 12d). In this case, the LST parameters are Sₚ=0.614 and α=0.633. The clearances of the bi-directional, partial LST bearing are lower compared to those of the unidirectional bearing at the same load. At a load of 460 N and at 1500 rpm; the clearance is 4.1 μm, while at 3000 rpm the clearance is 6 μm. These values represent a reduction of clearance between 33% and 10%, respectively, as compared to the unidirectional case. However, as can be seen from FIG. 16, the performance of the partial LST bidirectional bearing is still substantially better than that of the untextured bearing.

The friction coefficient of partial LST uni-directional and bidirectional bearings was compared with that of the untextured bearing in FIG. 17 at 1500 rpm. The friction coefficient of the two partial LST bearings is very similar, with slightly lower values in the case of the more efficient uni-directional bearing. The friction coefficient of the untextured bearing is much larger compared to that of the LST bearings. At the highest load of 460 N, the friction coefficient of the untextured bearing is about 0.025, as compared to about 0.01 for the LST bearings. At the lowest load of 160 N, the values are about 0.06 for the untextured bearing and around 0.02 for the LST bearings. Hence, the friction values of the untextured bearing are between 2.5 to 3 times higher than the corresponding values for the partial LST bearings over the entire load range.

In summary, the performance of both unidirectional and bidirectional partial LST bearings in terms of clearance and friction coefficient was compared with that of a baseline untextured bearing over a load range in which the theoretical model is valid. A dramatic, approximately three-fold increase in the clearance of the partial LST bearings compared to that of the untextured bearing was obtained over the entire load range. Consequently, the friction coefficient of the partial LST bearings is much lower, achieving more than a 50 percent reduction in friction as compared with the untextured bearing.

The larger clearance and lower friction make the partial LST simple parallel thrust bearing concept much more reliable and efficient, especially in seal-less pumps and similar applications where the process fluid, which is often a poor lubricant, is the only available lubricant for the bearings.

As used herein in the specification and in the claims section that follows, the term “the equivalent clearance convergence” and the like refers to an average reduction in the clearance between the opposing bearing surfaces. The term is specifically meant to include nominally-parallel bearing surfaces having micropores distributed so as to provide an equivalent clearance convergence effect.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A fluid-film bearing comprising:
(a) a first surface region having a first bearing surface, for attaching to a first machine component;
(b) a second surface region having a second bearing surface, for attaching to a second machine component;
said surface regions designed and configured such that said first surface and said second surface are disposed opposite one another,
said surface regions further designed and configured such that said first surface and said second surface move in a relative motion with respect to one another, and
(c) a fluid disposed between said surfaces,
wherein at least one of said surfaces is a micropore-containing surface having a plurality of micropores, said plurality of micropores disposed so as to effect an equivalent clearance convergence between said surfaces, in a direction of said relative motion, such that said relative motion, acting on said fluid, generates a pressure so as to generate a lifting force between said surfaces.

2. The bearing of claim 1, wherein said micropore-containing surface is parameterized by a width B* in said direction of said relative motion, and a length L*, and wherein L*/B* exceeds 0.2.

3. The bearing of claim 2, wherein L*/B* exceeds 0.3.

4. The bearing of claim 2, wherein L*/B* exceeds 0.5.

5. The bearing of claim 2, wherein L*/B* exceeds 0.7.

6. The bearing of claim 2, wherein L*/B* exceeds 1.0.

7. The bearing of claim 1, wherein said surfaces are nominally parallel.

8. The bearing of claim 2, wherein said surfaces are nominally parallel.

9. The bearing of claim 2, wherein a parameter a defines a ratio of surface area textured with said micropores to a total bearing surface area of said micropore-containing surface, and wherein α is between about 0.2 and about 0.9.

10. The bearing of claim 9, wherein α is between about 0.3 and about 0.8.

11. The bearing of claim 9, wherein α is between about 0.5 and about 0.7.

12. The bearing of claim 1, wherein a parameter Sₚ defines an area density of said micropores on said micropore-containing surface, and wherein Sₚ exceeds about 0.2.

13. The bearing of claim 12, wherein Sₚ exceeds about 0.4.

14. The bearing of claim 12, wherein Sₚ exceeds about 0.5.

15. The bearing of claim 1, wherein a parameter hₚ is a dimensionless dimple depth, said dimensionless dimple depth defined by:
hₚ=hₚ*/h₀*
wherein
hₚ* is a characteristic dimple depth of said micropores, and
h₀* is a minimum clearance between said surfaces,
and wherein hₚ exceeds about 0.5.

16. The bearing of claim 15, wherein hₚ exceeds about 0.6.

17. The bearing of claim 15, wherein hₚ exceeds about 0.75.

18. The bearing of claim 15, wherein said relative motion is bi-directional, and wherein said micropore-containing surface includes a first area and a second area, said first area disposed so as to effect an equivalent clearance convergence between said surfaces in a first direction of said relative motion, and said second area disposed so as to effect an equivalent clearance convergence between said surfaces in a second direction of said relative motion.
